(19) United States
(12) Patent Application Publication
(10) Pub. No.: US 2004/0240447 A1
(43) Pub. Date: Dec. 2, 2004

(54) Method and system for identifying bidirectional packet flow

(76) Inventors: Riccardo G. Dorbolo, Petaluma, CA (US); Michael Davis, (US)

Correspondence Address: Pepper Hamilton LLP, Firm 21269, 50th Floor, One Mellon Center, 500 Grant Street, Pittsburgh, PA, 15219, US

(21) Appl. No.: 10/857,703

(22) Filed: May 28, 2004

Related U.S. Application Data
(60) Provisional application No. 60/473,963, filed on May 28, 2003.

(51) Int. Cl. H04L 12/28

(52) U.S. Cl. 370/392; 370/395.32

(57) ABSTRACT

A system and method for generating a common flow identifier for messages flowing in each direction of a bidirectional message flow are disclosed. A packet classifier may extract header information from a packet and transform at least a subset of the header information into a flow identifier. The transformation may produce the same flow identifier for messages flowing in each direction of a bidirectional message flow. A hash table having entries for each bidirectional message flow may include the flow identifiers. The packet classifier may be used to control communications between an internal network and external resources.

### CROSS-REFERENCE TO RELATED APPLICATIONS

This patent application claims priority to, and incorporates by reference in its entirety, U.S. Provisional Patent Application No. 60/473,963, entitled “Method for Identifying Bidirectional Packet Flow” and filed May 28, 2003. This patent application incorporates by reference in its entirety each of the following co-pending U.S. patent applications: 1) “Policy Based Network Address Translation” filed on May 28, 2004; 2) “Method, System and Software for State Signing of Internet Resources” filed on May 28, 2004; and 3) “Multilayer Access Control Security System” filed on May 28, 2004.

### BACKGROUND

Access to computer networks is essential for the operation of most businesses today. Modem corporate computer networks are generally accessed not only by employees, but also by customers, partners and the general public. Accordingly, corporate computer networks are typically connected to the Internet to provide access to individuals not directly attached to the network.

As a result, such computer networks are subject to infiltration by unauthorized individuals. For example, intruders may attempt to gain access to sensitive data, use services for which they are not authorized or alter or corrupt the network in an attempt to either steal valuable information or harm the corporation or the corporation's equipment. Intrusion techniques include password sniffing, buffer overflows, denial-of-service attacks, Trojan horses and viruses.

One technique commonly used to protect corporate networks is to employ protection equipment (such as firewalls, routers, etc.) that controls access to internal resources. This type of protection equipment uses packet filtering to either block all packets (or other computer-based messages) except those that are specifically allowed, allow all packets except those that are specifically disallowed, or some combination of the two techniques. Packet filters examine particular packet fields to determine whether the packets constitute allowable traffic. Examined packet fields generally include an address or protocol identifier (e.g., Internet Protocol (IP) addresses of the source and/or destination computer, source and/or destination Transmission Control Protocol (TCP) or User Datagram Protocol (UDP) ports, or specific high-level communications protocol information). The protection equipment may use the information to decide whether to allow a packet to pass into a corporate network from the Internet.

Protection equipment may filter packets based solely on the contents of the specific packet being examined; that is, the packet will be allowed or blocked based solely on the addressing and protocol information within the packet. Alternatively, protection equipment may identify, for each packet, the “dialogue” to which the packet belongs. Each direction of this “dialogue” is commonly called a “packet flow” or simply a “flow,” and the dialogue is called a “bidirectional packet flow” or simply a “bidirectional flow”. For example, the stream of packets that forms a request from a web client (a personal computer running a web browser) that goes to a web server and the stream of packets that forms the response from the web server to the same web client, together, form a bidirectional flow.

Each packet entering a network protection device is classified into a particular flow. One way to identify a flow is to process key packet header information (source IP address, destination IP address, source port, destination port, and/or protocol) through a hash function and use the result to address a hash table. The hash function takes a block of data as an input, and produces a shortened version (called a hash or message digest) as output. The result of this method is to produce a shortened signature for the original data. Those skilled in the art will recognize that many types of hash functions would be suitable for this task.

Since many IP flows are bidirectional, efficient processing of these flows requires identifying each flow and identifying that the two flows are associated with each other. This is typically done using two hash table entries, each entry based on a single flow direction. Each direction of the flow is added to a flow table, and a reference is provided to associate the two flows with one another.

What is needed is a way to process a packet from a flow such that only a single hash table entry is required to identify and associate packets transmitted in both directions of a bidirectional flow.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “packet” is a reference to one or more packets and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

Computer messages, such as packets, transported on the Internet and on most Local Area Networks (“LANs”) today use the protocol suite commonly known as Transmission Control Protocol/Internet Protocol (“TCP/IP”). Those skilled in the art will recognize that packets transported using TCP or User Datagram Protocol (“UDP”) and IP contain header information that may include, among other things, source and destination parameters. The source and destination parameters may include a source port, a destination port, a source IP address, and a destination IP address. The source and destination parameters (e.g., the four parameters discussed above) may be used to classify a packet into a specific flow. The source and destination parameters are hereinafter referred to as an N-tuple. Two or more packets that have identical N-tuple values (e.g., same values for the four parameters) belong to the same flow.

In a bidirectional flow, the source and destination ports and IP addresses are typically switched. In an embodiment, a packet's N-tuple for both directions of a bidirectional flow is transformed in a way that results in a single transformed N-tuple. In an embodiment, the transformation involves performing one or more commutative arithmetic and/or logic operations on the source/destination parameters (e.g., source/destination port, source/destination IP address). In an embodiment, the transformation includes ordering (e.g., in ascending order) the source/destination parameters. A single hash table entry (index) may be created for both directions of a bidirectional flow based on the transformed N-tuple.

### BRIEF DESCRIPTION OF THE DRAWINGS

The accompanying drawings, which are incorporated in and form a part of the specification, illustrate various embodiments and, together with the description, serve to explain the principles of the various embodiments.

FIG. 1 illustrates an exemplary system architecture utilizing two layers of network protection equipment, according to an embodiment;

FIG. 2 illustrates an exemplary data path within an access management system, according to an embodiment;

FIGS. 3A and 3B illustrate an exemplary portion of a header of a TCP/IP packet flowing in each direction of a bidirectional packet flow, according to an embodiment;

FIGS. 4 and 5 illustrate exemplary transformations of N-tuples, according to embodiments; and

FIG. 6 illustrates an exemplary process for packet classification and filtering, according to an embodiment.

### DETAILED DESCRIPTION OF SPECIFIC EMBODIMENTS

In describing various embodiments illustrated in the drawings, specific terminology will be used for the sake of clarity. However, the specific terminology is not limited to a particular embodiment and in fact may be applied to multiple embodiments. Moreover, the embodiments are not intended to be limited to the specific terms so selected, and it is to be understood that each specific term includes all technical equivalents which operate in a similar manner to accomplish a similar purpose.

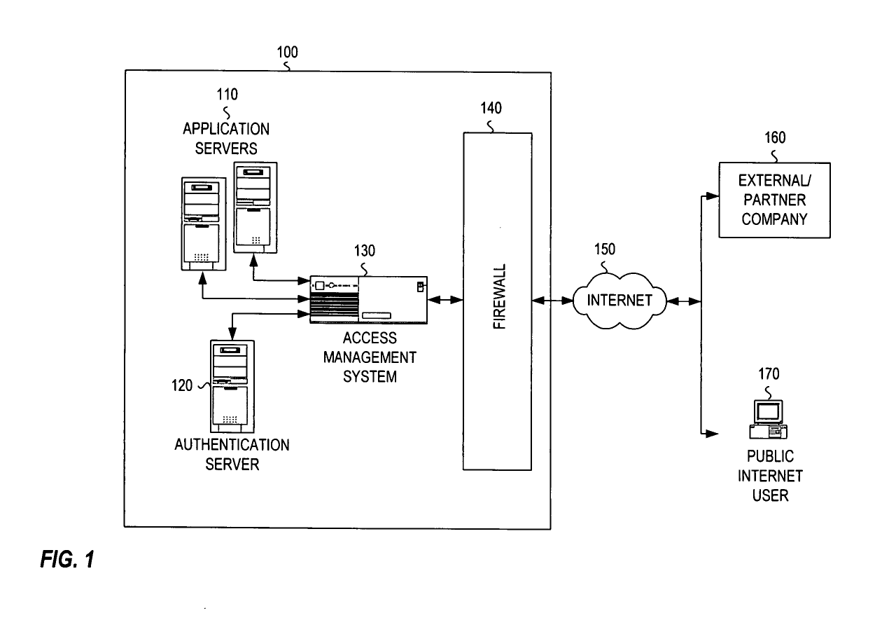

FIG. 1 illustrates an exemplary system architecture of a corporate network 100 connected to the Internet 150 through two layers of network protection equipment. The corporate network 100 may include one or more application servers 110, an authentication server 120, an access management system 130 and a firewall 140. The application servers 110 and the authentication server 120 may be connected to the access management system 130, which is connected to the Internet 150 through the firewall 140. An external/partner company 160 and/or a public Internet user 170 may also be connected to the Internet 150. In an exemplary operating scenario, the owner or maintainer of the corporate network 100 may desire to enable the external/partner company 160 to access the application servers 110 and to block the public Internet user 170. It should be understood that the exemplary system architecture is a simplified architecture for illustrative purposes. That is, a system architecture may include additional or fewer servers, external and partner companies and/or public Internet users.

The firewall 140 may provide traditional proxy/firewall protection based on simple packet analysis rules. The typical proxy/firewall may block most or all external intruders, while allowing users within the company to access internal resources and resources connected to the Internet 150. The access management system 130 may permit authenticated, secure access to internal server equipment (e.g., application servers 110) through the use of more complex, multi-layer packet filtering rules and means for authenticating users wishing to access resources within the company. Such authenticating means are well known to those of skill in the art. The present invention may be incorporated into any device that monitors both directions of an IP connection. For example, network listening devices or Protocol Analyzers may implement the present invention.

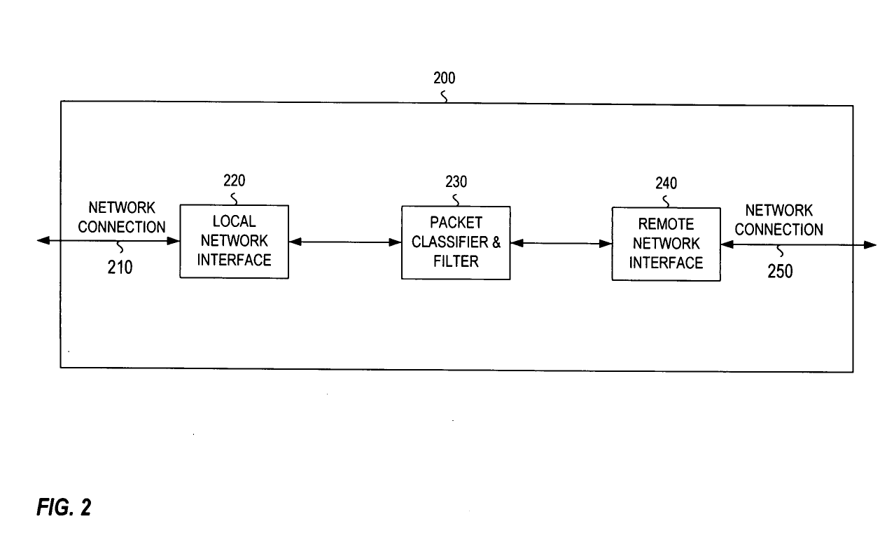

FIG. 2 illustrates an exemplary data path within an access management system 200. Packets from the corporate network (e.g., internal users) directed to the Internet may enter the access management system 200 over a network connection 210 and may be received by a local network interface 220. The local network interface 220 may forward the packets to a packet classifier and filter 230 for processing. Processed packets may be forwarded to a remote network interface 240 for transport to the Internet via network connection 250. Packets from the Internet (e.g., from external/partner company) directed to the corporate network may be received by the remote network interface 240 via the network connection 250, processed by the packet classifier and filter 230 and forwarded to the corporate network by the local network interface 220 via network connection 210. In an embodiment, the packet classifier and filter 230 is only connected to each network via a single network interface. The packet classifier and filter 230 may determine whether a packet has been sent from the remote (incoming) network or the local (outgoing) network.

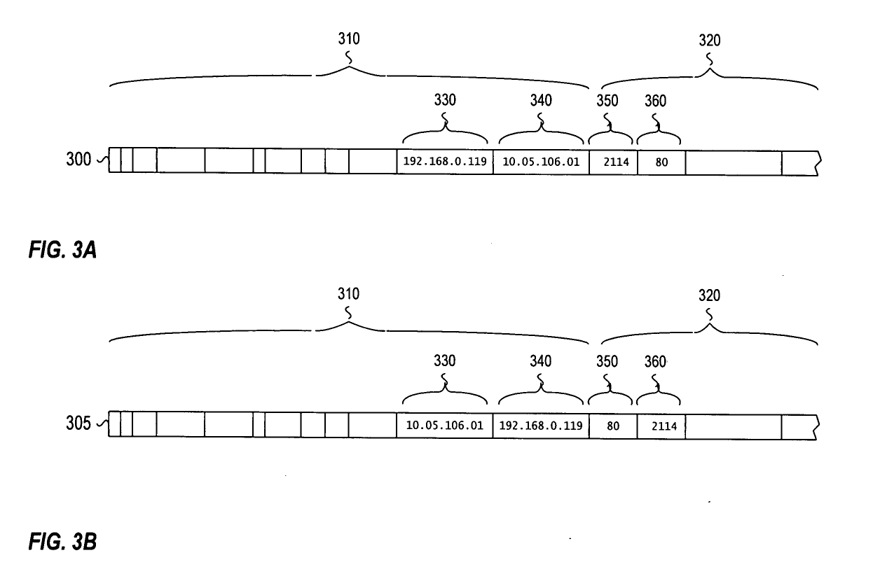

FIG. 3A illustrates an exemplary portion of a TCP/IP packet header 300 for packets flowing in a particular direction (e.g., internal user to external user). The TCP/IP packet header 300 includes an IP packet header 310 and a TCP header 320. The IP packet header 310 includes a source IP address 330 and a destination IP address 340. The TCP header 320 includes a source port 350 and a destination port 360. FIG. 3B illustrates an exemplary portion of a TCP/IP packet header 305 for packets flowing in a reverse direction to those of FIG. 3A (e.g., external user to internal user). The TCP/IP packet header 305 also includes an IP packet header 310 identifying source 330 and destination 340 IP addresses and a TCP header 320 identifying source 350 and destination 360 ports. TCP/IP header 305 is identical to TCP/IP header 300 with the exception that the values for the source IP address 330 and destination IP address 340 are swapped and the values for the source port 350 and the destination port 360 are swapped.

It should be noted that the IP address illustrated in FIGS. 3A and 3B is a so-called “Dotted Decimal” notation. The “Dotted Decimal” notation is an easy-to-read representation for a 32-bit binary number consisting of four 8-bit numbers, each written in decimal with periods (dots) separating them. It should also be noted that the 32 bit IP address is the current industry standard IPv4. However, the present disclosure is not limited to IPv4. Other standards, such as IPv6, are also included within the scope of this disclosure. Similar techniques may also be used with, for example, Ethernet source and destination MAC addresses or other type of messages including source and destination information.

Referring back to FIG. 2, the process of packet filtering may initially classify each packet transmitted to the packet classifier and filter 230 by extracting information from the packet and comparing the extracted information to entries in a table of permitted packet flows. Packets that are part of a permitted flow may be forwarded to their destination, while packets that are not part of a permitted flow may be terminated or dropped.

Information extracted from a packet for the purpose of classification may include, for example, the source port, the destination port, the source IP address, the destination IP address, a protocol type, a priority, a URL/URI and/or a Quality of Service (QoS). In addition, other parameters related to a packet may be used in place of or in addition to any of these parameters. Each of these parameters may be represented as a binary number. In an embodiment, port numbers may be 16-bit numbers, while IP addresses may be 32-bit numbers. The total number of bits representing the information that is extracted to classify a packet (flow identification) may be greater than or equal to 96 bits (16 bits each for source/destination port and 32 bits each for source/destination IP address plus one or more bits for additional parameters). Since a table indexed by the raw extracted information could be excessively large (e.g., 2⁹⁶ possible entries), in an embodiment, the present invention uses a hash table as an efficient way to store information based on a digest or hash of the large space (“key”). A properly designed hash function may be used to reduce the large key to a manageable size while largely avoiding “collisions.” A collision occurs when two or more entries produce the same hash value.

In the embodiment discussed herein, the collection of parameters extracted from a packet for the purpose of classification (flow identification) includes the source IP address, destination IP address, source port and destination port. This embodiment is illustrative only and is not intended to limit the use of other parameters as part of the classification process. The combination of the source port, destination port, source IP address and destination IP address for a packet is referred to herein as an N-tuple or a flow identifier.

In a bidirectional flow, the N-tuples for the two flow directions differ. Accordingly, the hash values also differ. Previous packet classifiers included a distinct hash table entry for each flow direction and an additional table to relate the two directions to a single bidirectional flow. However, the present invention makes use of the fact that the N-tuples for the two flow directions differ only in the source and destination ports, which are swapped, and the source and destination IP addresses, which are swapped, as illustrated in FIG. 3A and FIG. 3B and as discussed above.

In an embodiment, a packet's N-tuple is transformed in a way that results in the same transformed N-tuple for both directions of a bidirectional flow. The hash table index may then be generated based on the transformed N-tuple, instead of the original N-tuple. Accordingly, a single hash table entry representing both flow directions of the bidirectional packet flow may be created.

In an embodiment, the transformation involves performing one or more commutative arithmetic or logic operations on the source port and destination port and on the source IP address and destination IP address. By using a commutative operation, the result is guaranteed to be the same, regardless of the order of the source and destination parameters (port or IP address). Depending on the selected commutative operation(s), more than one operation may be required to generate unique transformed N-tuples. For example, if only an addition operation is used, many combinations of addresses and ports could result in the same transformed N-tuple. Commutative operation selection, including the number and/or type of operations used, may be based on the available hardware and/or software resources and may be implementation dependent.

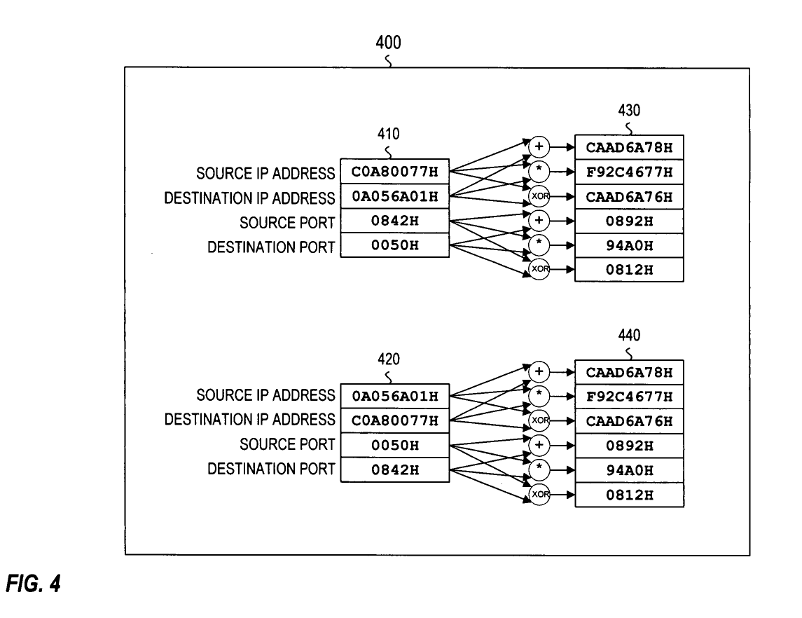

FIG. 4 illustrates an exemplary transformation 400 of N-tuples for a bidirectional flow. A transformation 400 may include, for example, three commutative operations (addition, multiplication and exclusive-OR) performed on the port numbers and IP addresses for each N-tuple. The results of these operations may form a transformed N-tuple. The transformed N-tuple is the same for each N-tuple. A first N-tuple 410 represents flow of a packet in a first direction (e.g., internal to external, server to client) and includes a first source IP address, first destination IP address, first source port and first destination port. A second N-tuple 420 represents flow of a packet in a second direction (e.g., external to internal, client to server) and includes a second source IP address, second destination IP address, second source port and second destination port. Since the two N-tuples 410, 420 are from the same bidirectional flow, the first source IP address, first destination IP address, first source port and first destination port are the same as the second destination IP address, second source IP address, second destination port and second source port, respectively.

A first transformed N-tuple 430 results from the application of the three commutative functions (addition, multiplication and exclusive-OR) to the IP address pair and the port pair in the first N-tuple 410. A second transformed N-tuple 440 results from the application of the three commutative functions to the IP address pair and the port pair in the second N-tuple 420. Since the operations are commutative, the two transformed N-tuples 430, 440 are identical. In the embodiment shown in FIG. 4, only the lower M bits of the results of these operations are preserved, where M is the size of the original number field (e.g., 32 bits for IPv4 IP addresses and 16 bits for port numbers). In alternate embodiments, a transformed N-tuple may include more or fewer bits for each operation.

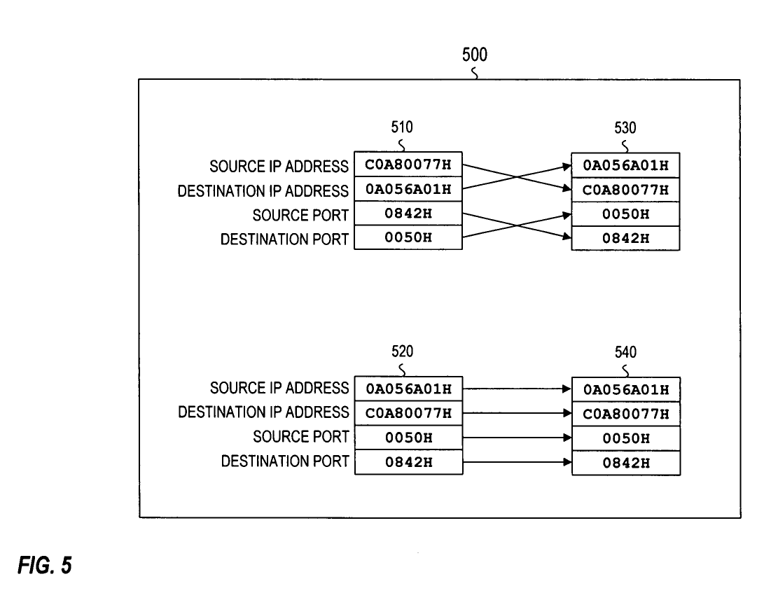

FIG. 5 illustrates a second exemplary transformation 500 of N-tuples for a bidirectional flow. The transformation 500 involves ordering (e.g., in ascending order) the source IP address and destination IP address and the source port and destination port for both N-tuples. This operation results in a transformed N-tuple for each N-tuple, where the transformed N-tuple is the same for each N-tuple. A first N-tuple 510 may represent a packet flow in a first direction (e.g., internal to external, server to client) and may include a first source IP address, first destination IP address, first source port and first destination port. A second N-tuple 520 may represent a packet flow in a second direction (e.g., external to internal, client to server) and may include a second source IP address, second destination IP address, second source port and second destination port. Again, since the two N-tuples 510, 520 are from the same bidirectional flow, the first source IP address, first destination IP address, first source port and first destination port are the same as the second destination IP address, second source IP address, second destination port and second source port, respectively.

A transformed N-tuple 530 may result from ordering the IP address pair and the port pair from N-tuple 510 in an ascending order. A transformed N-tuple 540 may be the same as the second N-tuple 520, in this case, because the second source and second destination IP addresses as well as the second source and second destination ports are already in ascending order (i.e., no reordering is required). Since the operations are commutative, the two transformed N-tuples 530, 540 are identical.

In operation, the result of a hash table lookup is examined to determine whether a collision occurred. This determination may be performed by storing a copy of the original N-tuple and/or the transformed N-tuple as part of each hash table entry and comparing the N-tuple used to generate the hash table index with the N-tuple(s) stored in the hash table. In an embodiment, only the first received N-tuple that maps to an entry is stored in the hash table. In such an embodiment, the collision check may include comparing a received N-tuple with the stored N-tuple. A determination of whether the received N-tuple is “outgoing” or “incoming” may further be based on whether the received N-tuple matches the stored N-tuple. In an embodiment, the hash table may provide a direction bit along with the record address so that the system can make this determination.

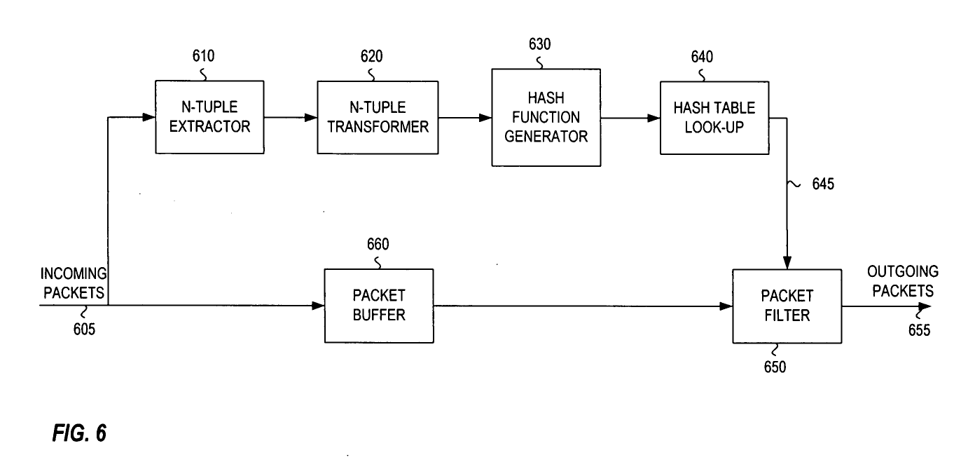

FIG. 6 illustrates an exemplary process for packet classification and filtering, according to an embodiment. Incoming packets 605 may be transmitted (one packet at a time) to an N-tuple extractor 610 where the packet header is examined and the appropriate parameters (e.g., source IP address, destination IP address, source port and destination port) are extracted. The extracted N-tuple may then be transmitted to an N-tuple transformer 620 where the N-tuple is transformed into a transformed N-tuple. The N-tuple transformer may create the transformed N-tuple utilizing various processes including those processes described above with respect to FIGS. 4 and 5. The transformed N-tuple may be fed into a hash function generator 630, which produces a hash of the transformed N-tuple. The hash value may be used to look up parameters associated with the flow in a hash table look-up 640. The hash table look-up 640 may include identifiers (e.g., access to resources and/or access to applications) for all bidirectional flows. The hash table look-up 640 may also include a copy of a non-transformed N-tuple to permit the determination of whether a packet is part of an incoming or outgoing flow. In an embodiment, the firewall software directs the hash logic to store the outgoing N-tuple (i.e., the non-transformed outgoing N-tuple is stored in the hash table look-up 640). When an incoming N-tuple is received, the hash table look-up 640 hashes to the same record as the outgoing N-tuple. However, since the received non-transformed N-tuple does not match the stored non-transformed N-tuple but the received transformed N-tuple matches the stored transformed N-tuple and the IP addresses and ports for the received and stored non-transformed N-tuples are merely swapped, the present invention may determine that the packet was part of an incoming flow. An output signal 645 from the hash table look-up 640 may be transmitted to a packet filter 650, which determines whether outgoing packet 655 should be forwarded or dropped. Moreover the output signal may determine whether the packet is processed as an incoming or an outgoing packet. A packet buffer 660 may buffer incoming packets 605 so that the output signal 645 related to a particular packet arrives at the packet filter 650 at the same time as the packet.

Computer program instructions to implement a software embodiment of the present invention may be stored in a computer program memory or on a computer readable carrier such as a disk, memory stick, portable memory device, communications signal or carrier wave. The instruments may be carried out in any computer programming language.

The many features and advantages of the invention are apparent from the detailed specification. Since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for associating processing parameters between messages flowing in each direction of a bidirectional flow, the method comprising:
extracting header information from a message flowing in a first direction of a bidirectional flow, wherein the header information includes at least one source parameter and at least one destination parameter;
applying at least one transformation to the at least one source parameter and the at least one destination parameter to generate a flow identifier, wherein the flow identifier is identical to a second flow identifier when generated by the at least one transformation for messages flowing in a second direction of a bidirectional flow;
retrieving one or more processing parameters from a parameter processing table based on the flow identifier; and
determining whether to forward the message based on at least one of the processing parameters.

2. The method of claim 1, wherein the flow identifier is a hash table key.

3. The method of claim 2, wherein retrieving one or more processing parameters comprises producing a hash of the hash table key.

4. The method of claim 1, wherein the at least one source parameter for the first message includes an Internet Protocol (“IP”) address for the source of the first message, wherein the at least one destination parameter for the first message includes an IP address for the destination of the first message, wherein the at least one source parameter for the second message includes an IP address for the source of the second message, and wherein the at least one destination parameter for the second message includes an IP address for the destination of the second message.

5. The method of claim 1, wherein the at least one source parameter for the first message includes a Transmission Control Protocol (“TCP”) port associated with the source of the first message, wherein the at least one destination parameter for the first message includes a TCP port associated with the destination of the first message, wherein the at least one source parameter for the second message includes a TCP port associated with the source of the second message, and wherein the at least one destination parameter for the second message includes a TCP port associated with the destination of the second message.

6. The method of claim 1, wherein the at least one source parameter for the first message includes a User Datagram Protocol (“UDP”) port associated with the source of the first message, wherein the at least one destination parameter for the first message includes a UDP port associated with the destination of the first message, wherein the at least one source parameter for the second message includes a UDP port associated with the source of the second message, and wherein the at least one destination parameter for the second message includes a UDP port associated with the destination of the second message.

7. The method of claim 1, wherein the at least one transformation includes a commutative arithmetic operation of the header information for a message.

8. The method of claim 7, wherein the commutative arithmetic operation includes a summation of at least one source parameter and at least one destination parameter for the message.

9. The method of claim 7, wherein the commutative arithmetic operation includes multiplication of at least one source parameter and at least one destination parameter for the message.

10. The method of claim 1, wherein the at least one transformation includes a commutative logical operation of the header information for a message.

11. The method of claim 10, wherein the commutative logical operation includes an exclusive-OR operation of at least one source parameter and at least one destination parameter for the message.

12. The method of claim 10, wherein the commutative logical operation includes an ordering operation of at least one source parameter and at least one destination parameter for the message.

13. The method of claim 1, further comprising:
determining a direction of the message based on one or more of the header information and the one or more processing parameters.

14. A device for generating a flow identifier for messages flowing in each direction of a bidirectional message flow, the device comprising:
an extractor, wherein the extractor extracts header information from a message, wherein the header information includes at least one source parameter related to a source of the message and at least one destination parameter related to a destination of the message; and
a transformer, wherein the transformer generates a flow identifier from the at least one source parameter and at least one destination parameter, wherein the transformer generates identical flow identifiers for messages transmitted in each direction of a bidirectional flow.

15. The device of claim 14, further comprising:
a hash generator, wherein the hash generator produces a hash of the flow identifier.

16. The device of claim 15, further comprising:
a hash lookup table, wherein the hash lookup table processes parameters associated with a bidirectional message flow identified by the hash.

17. The device of claim 14, wherein the header information includes one or more of an IP address, a TCP port, and a UDP port.

18. The device of claim 14, wherein the transformer sums at least one source parameter and at least one destination parameter.

19. The device of claim 14, wherein the transformer multiplies at least one source parameter and at least one destination parameter.

20. The device of claim 14, wherein the transformer performs an exclusive-OR operation of at least one source parameter and at least one destination parameter.

21. The device of claim 14, wherein the transformer orders at least one source parameter and at least one destination parameter.

22. A computer program embodied on a computer-readable medium having computer-executable instructions for generating a flow identifier for messages flowing in each direction of a bidirectional message flow, the computer program comprising:
a code segment for extracting header information from a message, wherein the header information includes at least one source parameter related to a source of the message and at least one destination parameter related to a destination of the message; and
a code segment for applying at least one transformation to the at least one source parameter and at least one destination parameter to generate a flow identifier, wherein an identical flow identifier is generated for messages transmitted in each direction of a bidirectional flow.

23. The computer program of claim 22, further comprising:
a code segment for producing a hash of the flow identifier; and
a code segment for reading flow identification information associated with the hash from a hash table.

24. The computer program of claim 22, wherein the at least one source parameter and the at least one destination parameter includes one or more of an IP address, a TCP port, and a UDP port.

25. The computer program of claim 22, wherein the at least one transformation includes one or more of summation, multiplication, an exclusive-OR operation, and ordering.

26. An access management system for controlling communications between an internal network and external resources, the system comprising:
a local network interface, wherein the local network interface communicates with an internal network;
a remote network interface, wherein the local network interface communicates with one or more external resources; and
a packet classifier and filter to control communications between the internal network and the one or more external resources, said packet classifier and filter including:
an extractor, wherein the extractor extracts header information from a packet, wherein the header information includes at least one source parameter related to a source of the message and at least one destination parameter related to a destination of the message,
a transformer, wherein the transformer generates a flow identifier from the at least one source parameter and at least one destination parameter, wherein the transformer generates identical flow identifiers for messages transmitted in each direction of a bidirectional flow,
a hash generator, wherein the hash generator produces a hash of the flow identifier, and
a hash lookup table, wherein the hash lookup table identifies processing parameters associated with a bidirectional message flow identified by the hash.

27. The system of claim 26, wherein the at least one source parameter and at least one destination parameter includes one or more of an IP address, a TCP port, and a UDP port.

28. The system of claim 26, wherein the at least one transformation includes one or more of summation, multiplication, an exclusive-OR operation, and ordering.
